(19) United States
(12) Patent Application Publication
(10) Pub. No.: US 2026/0291190 A1
(43) Pub. Date: Sep. 24, 2026

(54) ELECTRICAL JUNCTION BOX

(71) Applicant: SUMITOMO WIRING SYSTEMS, LTD., Yokkaichi-shi (JP)

(72) Inventors: Maiko ISSHIKI, Yokkaichi-shi (JP); Kiyofumi KAWAGUCHI, Yokkaichi-shi (JP)

(73) Assignee: SUMITOMO WIRING SYSTEMS, LTD., Yokkaichi-shi (JP)

(21) Appl. No.: 19/575,530

(22) Filed: Mar. 23, 2026

(30) Foreign Application Priority Data
Mar. 24, 2025 (JP) 2025-047670

(51) Int. Cl. H02G 3/03; H02G 3/08; H02G 3/10; H02G 3/16

(52) U.S. Cl. CPC H02G 3/03; H02G 3/081; H02G 3/10; H02G 3/16

(57) ABSTRACT

Provided is an electrical junction box that can increase heat transfer efficiency. An electrical junction box to be installed on a cooling surface includes: a case; a heat generating component accommodated in the case; and busbars. Each busbar has a heat transfer portion capable of transferring heat from the heat generating component to the cooling surface. A bottom wall of the case has a through hole extending through the bottom wall in the wall thickness direction. The heat transfer portions are disposed in the through hole.

### CROSS-REFERENCE TO RELATED APPLICATIONS

This application claims priority of Japanese Patent Application No. JP 2025-047670 filed on Mar. 24, 2025, the content of which is incorporated herein.

### TECHNICAL FIELD

The present disclosure relates to an electrical junction box.

### BACKGROUND

The electrical junction box in JP 2022-119554A includes a relay that generates heat during operation, an accommodation housing that accommodates the relay, and busbars connected to the relay. A bottom plate of the accommodation housing includes a different-material portion that has a higher thermal conductivity (thermal conductivity rate) than the other portion of the accommodation housing. The different-material portion is in contact with the busbars. The different-material portion is in contact with a battery pack disposed outside the accommodation housing. The battery pack has a cooling mechanism.

JP 2022-119554A is an example of related art.

### SUMMARY

As the voltage and current of electrical junction boxes increase, a large amount of heat is generated inside the electrical junction boxes. In the case of JP 2022-119554A, heat generated by the operation of the relay is transferred to the different-material portion via the busbars. Since the different-material portion has a higher thermal conductivity than the other portion of the accommodation housing, heat transferred to the different-material portion is transferred to the battery pack, thereby cooling the different-material portion. Since a heat transfer distance equivalent to the thickness of the different-material portion is required between the busbars and the battery pack, there is room for improvement from the viewpoint of heat transfer efficiency.

In view of this, the present disclosure aims to provide an electrical junction box that can increase the heat transfer efficiency.

The electrical junction box according to the present disclosure is an electrical junction box to be installed on a cooling surface, the electrical junction box including: a case; a heat generating component accommodated in the case; and a busbar, wherein the busbar has a heat transfer portion capable of transferring heat from the heat generating component to the cooling surface, and a bottom wall of the case has a through hole extending through the bottom wall in a wall thickness direction, and the heat transfer portion is disposed in the through hole.

According to the present disclosure, tit is possible to provide an electrical junction box that can increase heat transfer efficiency.

### BRIEF DESCRIPTION OF THE DRAWINGS

FIG. 1 is a perspective view of an electrical junction box according to Embodiment 1;

FIG. 2 is a perspective view showing a positional relationship of a bottom wall, busbars, and a heat generating component in the electrical junction box according to Embodiment 1;

FIG. 3 is a bottom view of the electrical junction box according to Embodiment 1;

FIG. 4 is a side cross-sectional view of the electrical junction box according to Embodiment 1;

FIG. 5 is an enlarged transverse cross-sectional view of a heat transfer portion to which an insulating resin layer is attached and a surrounding portion thereof in the electrical junction box according to Embodiment 1; and

FIG. 6 is a view equivalent to FIG. 5 of the electrical junction box according to Embodiment 1, in which a heat transfer portion is surrounded by an insulating tube.

### DETAILED DESCRIPTION OF PREFERRED EMBODIMENTS

First, embodiments according to the present disclosure will be listed and described.

An electrical junction box according to the present disclosure is

(1) an electrical junction box to be installed on a cooling surface, the electrical junction box including: a case; a heat generating component accommodated in the case; and a busbar, wherein the busbar has a heat transfer portion capable of transferring heat from the heat generating component to the cooling surface, a bottom wall of the case has a through hole extending through the bottom wall in a wall thickness direction, and the heat transfer portion is disposed in the through hole.

According to the configuration (1) above, compared to a case where the heat transfer portion is installed on the bottom wall, the heat transfer distance corresponding to the wall thickness of the bottom wall can be shortened and the efficiency of heat transfer to the cooling surface can be increased.

(2) In the electrical junction box according to (1) above, it is preferable that an insulating portion is provided between a plate surface of the heat transfer portion and the cooling surface.

According to the configuration (2) above, insulation between the heat transfer portion and the cooling surface can be ensured.

(3) In the electrical junction box according to (2) above, it is preferable that the insulating portion is also provided between a plate thickness surface of the heat transfer portion and an inner surface of the through hole.

According to the configuration (3) above, even when a foreign object is accidentally interposed between the plate thickness surface of the heat transfer portion and the inner surface of the through hole, the insulation of the heat transfer portion from the cooling surface can be favorably ensured.

(4) In the electrical junction box according to (2) or (3) above, it is preferable that the insulating portion is constituted by an insulating resin layer attached to at least a heat transfer surface of the plate surface of the heat transfer portion facing the cooling surface.

According to the configuration (4) above, when the insulating portion is provided, a plurality of busbars may be treated at once by painting, immersion, or the like, thereby increasing productivity.

(5) In the electrical junction box according to (2) or (3) above, it is preferable that the insulating portion is constituted by an insulating tube that surrounds the heat transfer portion.

According to the configuration (5) above, the entire outer periphery of the heat transfer portion can be favorably insulated.

(6) In the electrical junction box according to any one of (2) to (5) above, it is preferable that a corner of the busbar has a rounded surface shape, and the corner is covered with the insulating portion.

According to the configuration (6) above, compared to a case where the corner is edge-shaped, the insulating resin can cover the corner more reliably, and thus the insulation of the corner can be ensured.

(7) In the electrical junction box according to any one of (2) to (6) above, it is preferable that the busbar has a rising portion that is bent in a direction away from the bottom wall relative to the heat transfer portion, and the insulating portion is provided to cover a portion extending from the heat transfer portion to the rising portion.

According to the configuration (7) above, a creepage distance of the busbar from the cooling surface can be properly ensured.

(8) In the electrical junction box according to any one of (2) to (7) above, it is preferable that an insulating seal is interposed between the insulating portion and the cooling surface to fill a gap between the insulating portion and the cooling surface.

According to the configuration (8) above, since the gap between the insulating portion and the cooling surface is filled, the efficiency of heat transfer to the cooling surface can be further increased.

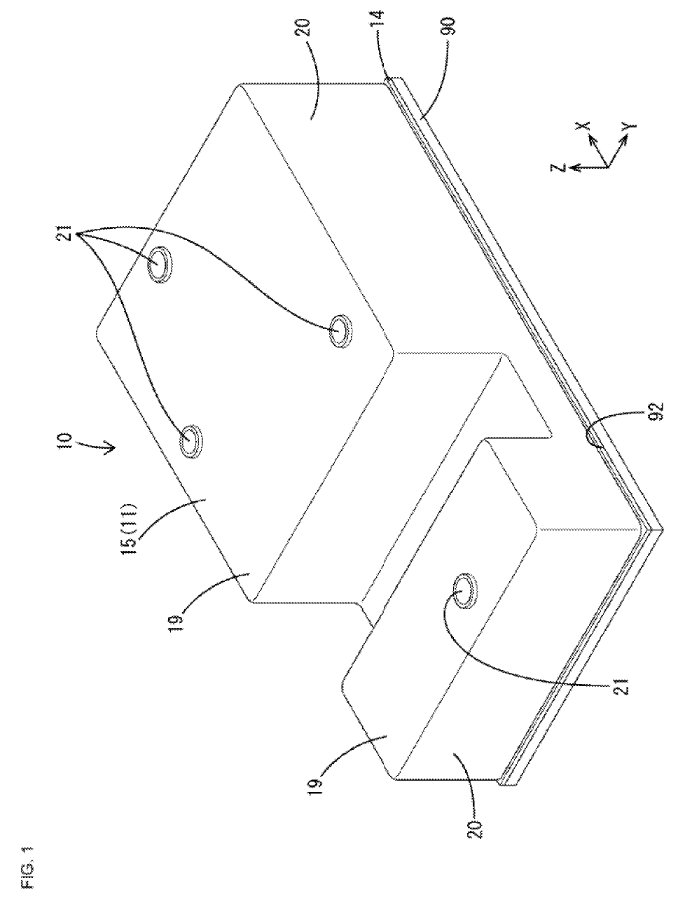

Specific examples of embodiments according to the present disclosure will be described below with reference to the drawings. Note that the present disclosure is not limited to these examples, but is indicated by the claims and is intended to include all changes within the meaning and scope of the claims and equivalents. An electrical junction box 10 according to Embodiment 1 of the present disclosure is provided, for example, on a battery pack 90 mounted on a vehicle such as an electric vehicle. X, Y, and Z in FIG. 1 represent the forward, right, and upward directions, respectively. These directional references are merely for convenience and do not necessarily match the directional references in a state in which the electrical junction box 10 is mounted on a vehicle (not shown) or the like.

### Embodiment 1

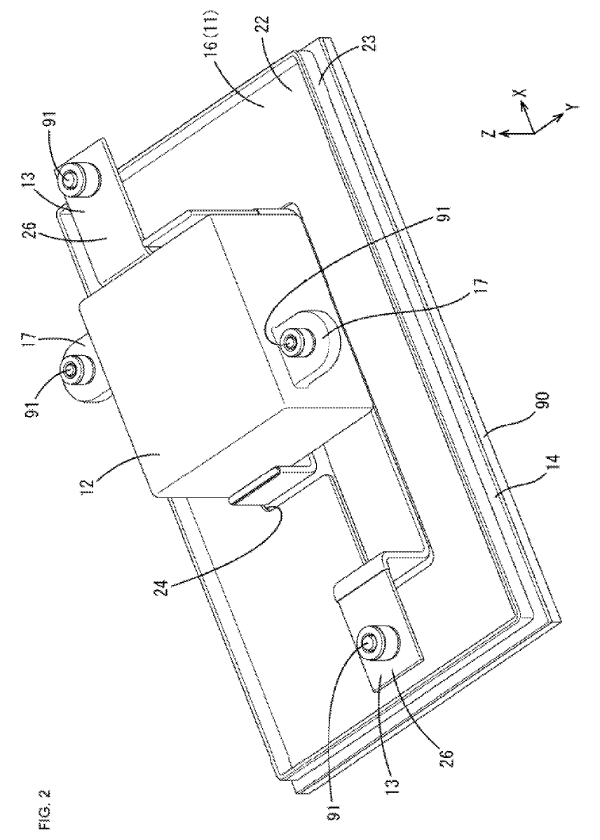

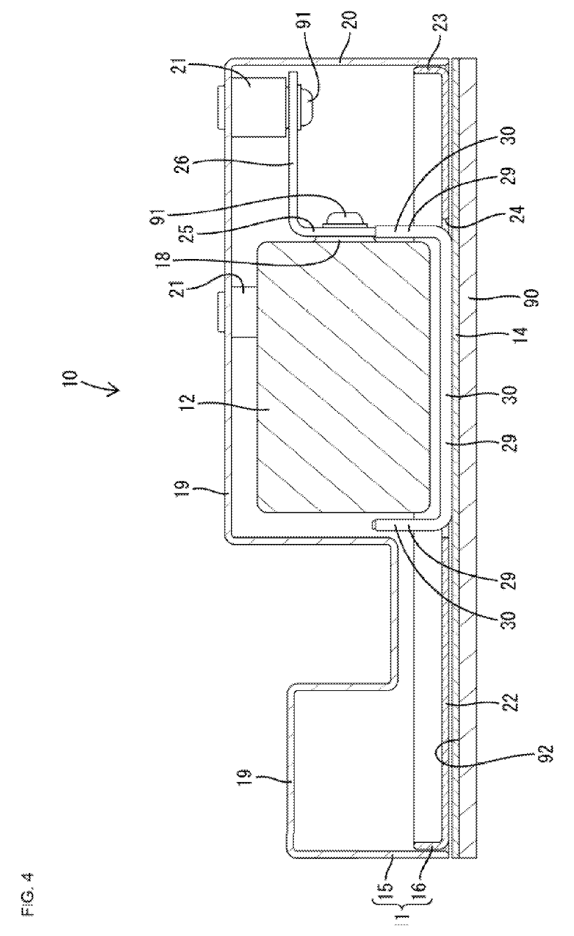

As shown in FIG. 1, the electrical junction box 10 is placed on a cooling surface 92, which is an upper surface of the battery pack 90 (cooling portion) (for convenience of drawing, only a part of the battery pack 90 is shown). Although not shown in its entirety, the battery pack 90 is made of metal and has a box shape. The cooling surface 92 has a planar shape. As shown in FIG. 2, the electrical junction box 10 includes a case 11, a heat generating component 12 accommodated in the case 11, and a plurality of busbars 13 connected to the heat generating component 12. As shown in FIG. 4, an insulating seal 14 is interposed between a heat transfer portion 27 (to be described later) of the busbar 13 and the cooling surface 92, to fill the gap between the heat transfer portion 27 and the cooling surface 92. The insulating seal 14 is placed on the cooling surface 92 in a range where the electrical junction box 10 is mounted. In Embodiment 1, the insulating seal 14 is an insulating gap filler. The gap filler is made of, for example, silicone grease or the like, has high thermal conductivity and good insulating properties, is in a paste-like form, and is configured to fill the gap and uneven surfaces. The case 11 is made of insulating resin. As shown in FIG. 4, the case 11 is constituted by an upper case 15 and a lower case 16. The upper case 15 is attached to the lower case 16 from above. The upper case 15 and the lower case 16 are locked to each other by a case lock (not shown).

### Heat generating component 12

As shown in FIG. 2, the heat generating component 12 has a rectangular parallelepiped box shape. In Embodiment 1, the heat generating component 12 is a relay. The heat generating component 12 generates heat during operation. Although not shown, the heat generating component 12 is connected to an external power supply. A pair of first case fixing portions 17 are provided on the left and right side surfaces of the heat generating component 12. The heat generating component 12 is fixed to the upper case 15 by screwing bolts 91 into screw receiving portions 21 (described later) of the upper case 15 and the first case fixing portions 17.

A pair of busbar fixing portions 18 are provided on a front surface of the heat generating component 12. The heat generating component 12 and the busbars 13 are connected to each other by screwing bolts 91 into the busbar fixing portions 18 and connection portions 25 (described later) of the busbars 13.

### Upper case 15

As shown in FIG. 1, the upper case 15 has a top plate 19 that is rectangular in plan view and four side plates 20 that extend downward respectively from sides of the top plate 19. The top plate 19 is disposed with the plate surface facing in the up-down direction. The top plate 19 has recesses that are recessed downward to match the arrangement of the heat generating component 12 and the busbars 13 that are accommodated in the case 11.

An inner surface of the top plate 19 has a plurality of screw receiving portions 21 that protrude downward. The screw receiving portions 21 are disposed at positions corresponding to the first case fixing portions 17 and multiple second case fixing portions 26 (described later) of the busbars 13. The heat generating component 12 and the busbars 13 can be fixed to the upper case 15 by screwing the bolts 91 into the first case fixing portions 17, the second case fixing portions 26, and the screw receiving portions 21.

Each side plate 20 has a flat plate shape extending along the up-down direction. Of the side plates 20, the left and right side plates 20 are shaped to be recessed downward at positions corresponding to the recesses of the top plates 19. The side plates 20 are arranged to surround the heat generating component 12 and the busbars 13 in a state where the upper case 15 is attached to the lower case 16.

### Lower case 16

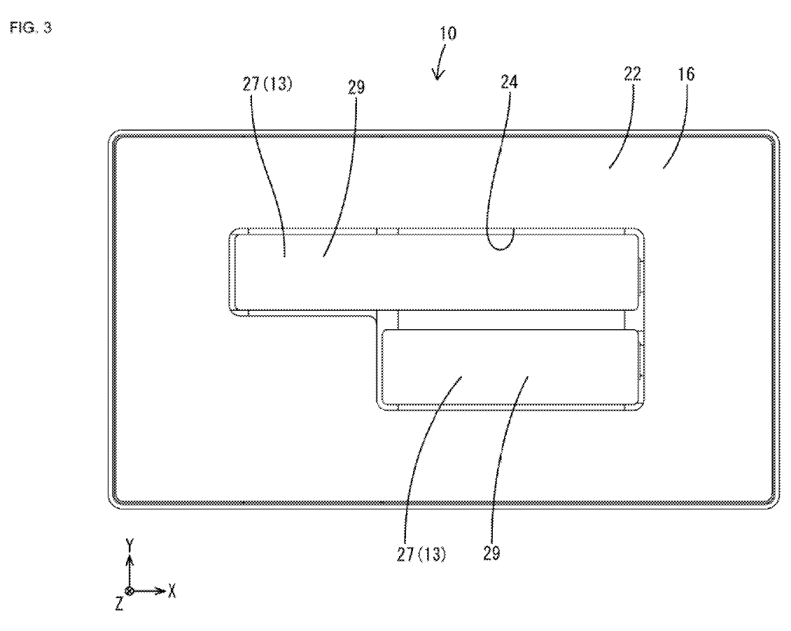

As shown in FIG. 2, the lower case 16 has a bottom wall 22 that is rectangular in plan view and a peripheral wall 23 that extends upward from sides of the bottom wall 22. The bottom wall 22 has a flat plate shape and is disposed with the plate surface thereof facing in the up-down direction. As shown in FIGS. 3 and 4, a through hole 24 extending through the bottom wall 22 in the up-down direction (wall thickness direction) is formed in an intermediate portion of the bottom wall 22 in the left-right direction. As shown in FIG. 3, the through hole 24 is shaped to extend along the front and rear ends and side edges of the heat transfer portions 27 (described later) of the busbars 13 in a bottom view (plan view). The inner surface of the through hole 24 is adjacent to and faces parallel to a plate thickness surface (described later) of the busbars 13. In addition, the inner surface of the through hole 24 also faces a portion where the heat transfer portions 27 are connected to rising portions 30 (described later) of the busbars 13.

The peripheral wall 23 is continuous along the entire periphery of the sides of the bottom wall 22. The vertical dimension of the peripheral wall 23 is smaller than the vertical dimension of a downwardly recessed portion of the left and right side plates 20 of the upper case 15. In other words, when the upper case 15 and the lower case 16 are attached to each other, the peripheral wall 23 and the top plate 19 face each other with a gap therebetween in the up-down direction. In addition, the peripheral wall 23 is disposed to be surrounded by the side plates 20.

### Busbar 13

Each busbar 13 is made of metal and has a flat plate shape. Each busbar 13 has a higher thermal conductivity than the case 11. In Embodiment 1, as shown in FIG. 2, two busbars 13 are arranged side by side in the left-right direction. In the following description, for convenience, the left busbar 13 in FIG. 2 will be described in detail, and the right busbar 13 in FIG. 2 will be described as needed. Although the two busbars 13 have different shapes, the components are the same, and therefore the corresponding components are given the same reference numerals and names. Note that the busbar 13 shown in FIG. 4 is the left busbar 13 in FIG. 2.

As shown in FIG. 4, the busbar 13 has a connection portion 25 connected to the busbar fixing portion 18 of the heat generating component 12. The connection portion 25 is arranged such that the plate surface thereof is aligned with the front surface of the heat generating component 12. Although not shown, the connection portion 25 has a hole extending through the connection portion 25 in the thickness direction. The busbar 13 is connected to the heat generating component 12 by screwing a bolt 91 into the hole in a state where the connection portion 25 is in contact with the busbar fixing portion 18. The surface of the connection portion 25 is not covered with insulating resin or the like.

The busbar 13 has a second case fixing portion 26 that is bent and extends forward from an upper end of the connection portion 25. The second case fixing portion 26 is disposed with the plate surface thereof facing in the up-down direction. Although not shown, the second case fixing portion 26 has a hole extending through the second case fixing portion 26 in the thickness direction. The busbar 13 is fixed to the upper case 15 by screwing a bolt 91 into the hole in a state where the second case fixing portion 26 is in contact with a screw receiving portion 21. Note that the second case fixing portion 26 of the right busbar 13 in FIG. 2 is bent and extends rearward from an upper end of the rising portion 30, which will be described later.

The busbar 13 has the heat transfer portion 27 disposed below the bottom surface of the heat generating component 12. The heat transfer portion 27 has a higher thermal conductivity than the case 11. The heat transfer portion 27 extends in the front-rear direction with the plate surfaces thereof facing in the up-down direction. The plate surfaces of the heat transfer portion 27 are upper and lower surfaces. The heat transfer portion 27 faces the bottom surface of the heat generating component 12. The heat transfer portion 27 of the right busbar 13 in FIG. 2 is formed to be longer in the front-rear direction than the heat transfer portion 27 of the left busbar 13. In addition, as shown in FIG. 3, the heat transfer portions 27 arranged side by side in the left-right direction are spaced apart from each other and are not in contact with each other.

As shown in FIGS. 3 and 4, the heat transfer portions 27 are disposed in the through hole 24 in the lower case 16. The heat transfer portions 27 are disposed at a distance from the bottom wall 22 and are not in contact with the bottom wall 22. The upper surfaces of the heat transfer portions 27 face the upper surface of the bottom wall 22 of the lower case 16. The lower surfaces of the heat transfer portions 27 face the lower surface of the bottom wall 22. The thickness of the heat transfer portions 27 is larger than the thickness of the bottom wall 22 of the lower case 16. In other words, the lower surfaces of the heat transfer portions 27 protrude downward relative to the lower surface of the bottom wall 22.

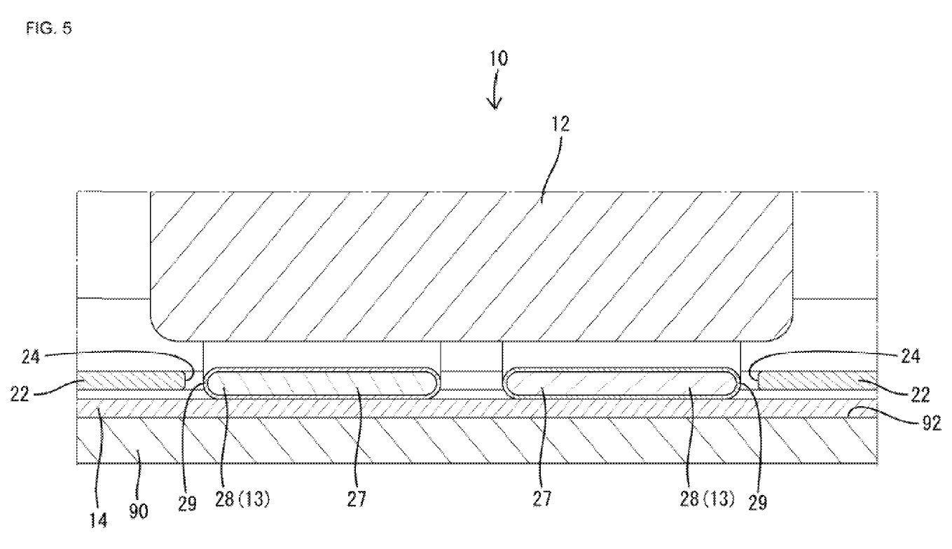

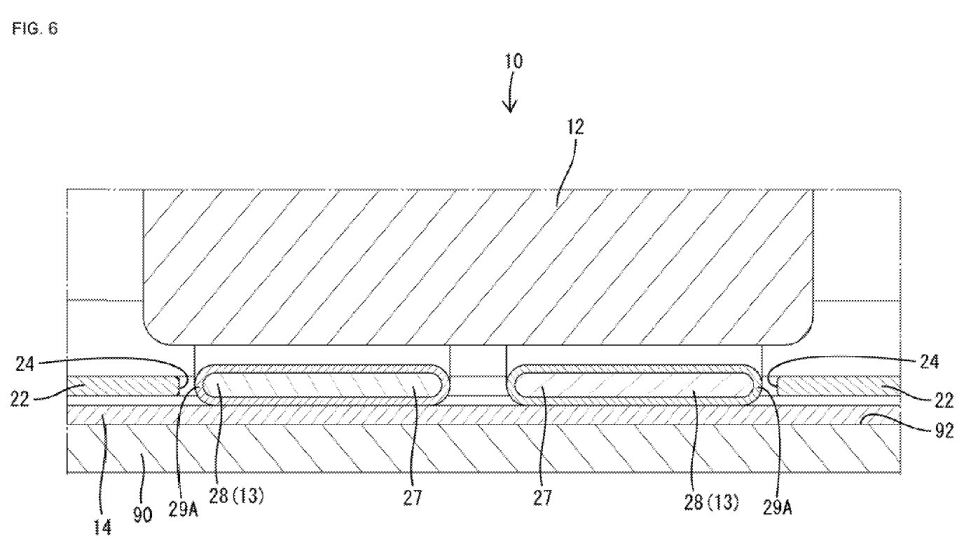

As shown in FIG. 5, corners 28 of each busbar 13 in the width direction have a rounded surface shape. Although the shape of the corners 28 of only the heat transfer portion 27 is shown in FIG. 5, the corners 28 of the entire busbar 13 have a rounded surface shape. The entire peripheral surface of the heat transfer portion 27, including the corners 28, is an insulating portion 29 covered by insulating resin. The insulating portion 29 is provided between the plate thickness surface of the heat transfer portion 27 and the inner surface of the through hole 24. Note that the plate thickness surfaces of the heat transfer portions 27 are left and right side surfaces. As shown in FIG. 6, an insulating portion 29A may be provided using an insulating tube instead of insulating resin. The insulating portion 29A surrounds the heat transfer portion 27. It is possible to use, for example, a heat-shrinkable tube or resin tube as the insulating tube.

As shown in FIG. 4, the lower surface of the heat transfer portion 27 (insulating portion 29) protrudes downward relative to the lower surface of the bottom wall 22. Therefore, in the process of installing the electrical junction box 10 on the cooling surface 92, the insulating portion 29 always comes into contact with the insulating seal 14 earlier than the bottom wall 22.

The busbar 13 has a pair of rising portions 30 that are bent upward (in a direction away from the bottom wall 22 and the cooling surface 92) from both ends of the heat transfer portion 27 in the front-rear direction. The rising portions 30 are disposed with the plate surfaces thereof facing in the front-rear direction. An upper end of the front rising portion 30 is continuous with the connection portion 25. The rear rising portion 30 is disposed along a rear surface of the heat generating component 12. In the right busbar 13 in FIG. 2, an upper end of the rear rising portion 30 is continuous with the second case fixing portion 26. The entire peripheral surface of the rising portions 30, including the corners 28, is the insulating portion 29 covered with insulating resin. The rising portions 30 are disposed at a distance from the front and rear surfaces of the heat generating component 12 and are not in contact with the front and rear surfaces of the heat generating component 12.

### Method for manufacturing busbar 13

Next, an example of a method for manufacturing the busbar 13 will be described. In Embodiment 1, the busbar 13 is formed into a predetermined shape by forming a metal rod member having a circular cross section. In more detail, the rod member is formed into a flat plate shape using a multi-forming machine, and bent while the orientation of the rod member is changed as needed. Since the rod member having a circular cross section is subjected to forming, the corners 28 of the busbar 13 have a rounded surface shape.

The insulating portion 29 is formed by subjecting the busbar 13 to powder coating. Specifically, the busbar 13 is subjected to insulating coating by an electrostatic coating method using an insulating resin such as epoxy resin. Powdery insulating resin is sprayed onto the busbar 13to cause the insulating resin to adhere to the surfaces of the heat transfer portion 27 and the rising portions 30. The insulating resin and the busbar 13 are heated, dried, and then cooled to form the insulating portion 29.

As shown in FIG. 5, the corners 28 of each busbar 13 have a rounded surface shape, and thus the corners 28 also become the insulating portion 29 covered with the insulating resin through the above-described insulating coating. This allows the corners 28 to be reliably covered with the insulating resin, compared to the case where the corners of a busbar have an edge shape.

Also, in Embodiment 1, not only the surface of the heat transfer portion 27 but also the surfaces of the rising portions 30 are formed as the insulating portions 29 covered with insulating resin. This ensures an appropriate creepage distance of the busbar 13 from the battery pack 90 (cooling surface 92).

As shown in FIG. 6, the insulating portion 29A may be provided using an insulating tube that surrounds the heat transfer portion 27. In this case, the entire outer periphery of the heat transfer portion 27 can be favorably insulated.

### Effects of electrical junction box 10

When the heat generating component 12 is activated, the heat generating component 12 generates heat. The heat generated by the heat generating component 12 is transferred from the busbar fixing portions 18 of the heat generating component 12 to the connection portions 25 of the busbars 13. The heat transferred to the connection portions 25 is transferred to the heat transfer portions 27 disposed in the through hole 24. Therefore, the heat is then dissipated from the heat transfer portions 27 to the cooling surface 92 via the insulating seal 14. As described above, the heat generated inside the electrical junction box 10 is dissipated to the battery pack 90 outside the electrical junction box 10.

As shown in FIG. 4, the heat transfer portions 27 are disposed in the through hole 24, and thus the heat transfer portions 27 can dissipate heat to the cooling surface 92 without the heat passing through the bottom wall 22. Therefore, compared to the case where the heat transfer portions are disposed on the upper surface of the bottom wall, the distance between the heat transfer portions 27 and the cooling surface 92 can be shortened by the thickness of the bottom wall 22, thereby increasing the efficiency of heat transfer to the cooling surface 92. Also, since the lower surfaces of the heat transfer portions 27 protrude downward from the lower surface of the bottom wall 22, the insulating portion 29 always comes into contact with the insulating seal 14 earlier than the bottom wall 22. This separates the case 11 from the battery pack 90, thus ensuring insulation within the case 11. Furthermore, since the gap between the insulating portions 29 or 29A (heat transfer portions 27) and the cooling surface 92 is filled by the insulating seal 14, the efficiency of heat transfer to the cooling surface 92 can be further increased.

As described above, the electrical junction box 10 to be installed on the cooling surface 92 includes: the case 11; the heat generating component 12 accommodated in the case 11; and the busbars 13. Each busbar 13 has the heat transfer portion 27 capable of transferring heat from the heat generating component 12 to the cooling surface 92. The bottom wall 22 of the case 11 has the through hole 24 extending through the bottom wall 22 in the wall thickness direction (up-down direction). The heat transfer portions 27 are disposed in the through hole 24. As a result, compared to the case where the heat transfer portions are disposed on the upper surface of the bottom wall, the distance between the heat transfer portions 27 and the cooling surface 92 can be shortened by the thickness of the bottom wall 22, thereby increasing the efficiency of heat transfer to the cooling surface 92.

The insulating portions 29 or 29A are provided between the plate surfaces (lower surfaces) of the heat transfer portions 27 and the cooling surface 92. This ensures insulation between the heat transfer portions 27 and the cooling surface 92.

The insulating portions 29 or 29A are provided between the plate thickness surfaces (left and right side surfaces) of the heat transfer portions 27 and the inner surface of the through hole 24. This ensures favorable insulation of the heat transfer portions from the cooling surface, even when a foreign object is accidentally interposed between the plate thickness surfaces of the heat transfer portions and the inner surface of the through hole.

Each insulating portion 29 is constituted by an insulating resin layer attached to at least the heat transfer surface (lower surface) of the plate surface of the heat transfer portion 27 facing the cooling surface 92. This allows a plurality of busbars 13 to be treated at once by painting, immersion, or the like when providing the insulating portion 29, thereby increasing productivity.

Each insulating portion 29A is constituted by an insulating tube that surrounds the heat transfer portion 27. This allows the entire outer periphery of the heat transfer portion 27 to be favorably insulated.

The corners 28 of each busbar 13 have a rounded surface shape, and the corners 28 are covered with the insulating portion 29 or 29A. This allows the insulating resin to cover the corners 28 more reliably compared to the case where the corners are edge-shaped, ensuring the insulation of the corners 28.

Each busbar 13 has the rising portions 30 bent in a direction (upward) away from the bottom wall 22 relative to the heat transfer portion 27, and the insulating portion 29 or 29A is provided to cover a portion extending from the heat transfer portion 27 to the rising portions 30. This allows the creepage distance of the busbar 13 from the cooling surface 92 to be properly ensured.

The insulating seal 14 is interposed between the insulating portions 29 or 29A and the cooling surface 92 to fill the gap between the insulating portions 29 or 29A and the cooling surface 92. As a result, the gap between the insulating portions 29 or 29A and the cooling surface 92 is filled, and thus the efficiency of heat transfer to the battery pack 90 (the cooling portion) can be further increased.

### Other Embodiments of the Present Disclosure

The embodiments disclosed above in this application are to be considered in all respects as illustrative and not restrictive.

In Embodiment 1, the heat from the heat generating component 12 is dissipated to the cooling surface 92 via the busbars 13. In contrast, in other embodiments, heat from the heat generating component may be dissipated to the cooling surface via a member other than the busbars. For example, a resin or the like having a high thermal conductivity may be used instead of the busbars.

In Embodiment 1, the insulating portion 29 is made of an insulating resin. In contrast, in other embodiments, the insulating portion may be an insulating sheet instead of an insulating resin.

In Embodiment 1, the case 11 is made of resin. In contrast, in other embodiments, the case may be made of metal instead of resin.

In Embodiment 1, the insulating seal 14 is a gap filler. In contrast, in other embodiments, the insulating seal may be an insulating heat dissipating grease instead of a gap filler.

In Embodiment 1, the insulating portion 29 is constituted by an insulating resin layer covering the entire periphery of the heat transfer portion 27. In contrast, in other embodiments, only the heat transfer surface of the heat transfer portion (a surface facing the cooling surface) may serve as an insulating portion covered with the insulating resin layer. In other words, the entire periphery of the heat transfer portion does not need to be covered with the insulating resin layer.

In Embodiment 1, the heat transfer portion 27 is a portion of the busbar 13. In contrast, in other embodiments, the heat transfer portion may be the entire busbar (when the entire busbar is accommodated in the through hole).

In Embodiment 1, the busbars 13 are disposed together in the through hole 24. In contrast, in other embodiments, a through hole may be provided in correspondence with each busbar.

What is claimed is:

1. An electrical junction box to be installed on a cooling surface, the electrical junction box comprising:
a case;
a heat generating component accommodated in the case; and
a busbar,
wherein the busbar has a heat transfer portion capable of transferring heat from the heat generating component to the cooling surface,
a bottom wall of the case has a through hole extending through the bottom wall in a wall thickness direction, and
the heat transfer portion is disposed in the through hole.

2. The electrical junction box according to claim 1,
wherein an insulating portion is provided between a plate surface of the heat transfer portion and the cooling surface.

3. The electrical junction box according to claim 2,
wherein the insulating portion is also provided between a plate thickness surface of the heat transfer portion and an inner surface of the through hole.

4. The electrical junction box according to claim 3,
wherein the insulating portion is constituted by an insulating resin layer attached to at least a heat transfer surface of the plate surface of the heat transfer portion facing the cooling surface.

5. The electrical junction box according to claim 3,
wherein the insulating portion is constituted by an insulating tube that surrounds the heat transfer portion.

6. The electrical junction box according to claim 3,
wherein a corner of the busbar has a rounded surface shape, and
the corner is covered with the insulating portion.

7. The electrical junction box according to claim 3,
wherein the busbar has a rising portion that is bent in a direction away from the bottom wall relative to the heat transfer portion, and
the insulating portion is provided to cover a portion extending from the heat transfer portion to the rising portion.

8. The electrical junction box according to claim 2,
wherein an insulating seal is interposed between the insulating portion and the cooling surface to fill a gap between the insulating portion and the cooling surface.
